(19) United States
(12) Patent Application Publication
(10) Pub. No.: US 2024/0149246 A1
(43) Pub. Date: May 9, 2024

(54) THERMO BIMETALLIC ALLOY FINS FOR REGIONAL HEATING OF ADSORBENT REACTORS

(71) Applicant: CARBON CAPTURE INC., Pasadena, CA (US)

(72) Inventor: Rama ADAJIAN, Los Angeles, CA (US)

(21) Appl. No.: 18/501,849

(22) Filed: Nov. 3, 2023

Related U.S. Application Data
(60) Provisional application No. 63/382,215, filed on Nov. 3, 2022.

(51) Int. Cl. B01J 20/34; B01D 53/04; B01J 20/28

(52) U.S. Cl. CPC B01J 20/3483; B01D 53/0438; B01J 20/28042; B01D 2253/342; B01D 2257/504; B01D 2257/80; B01D 2258/06; B01D 2259/4009

(57) ABSTRACT

Systems and methods for the efficient regeneration of sorbents, such as those used for the direct capture and separation of carbon dioxide and/or water from the atmosphere are provided. Temperature responsive bimetallic alloy strips, gores, or sheets are utilized as heat-responsive fins embedded into and extending out of the adsorbent bed to guide heated gas flows to cooler regions of the adsorbent bed undergoing regeneration. The invention allows for more rapid and more even heating of adsorbent beds to effect more efficient desorption of one or more chemical moieties adsorbed thereon. In particular, the invention is useful for the desorption of carbon dioxide from adsorption beds utilized for direct air capture (DAC) of carbon dioxide as well as the desorption of water from adsorption beds utilized for atmospheric harvesting of water.

### CROSS-REFERENCE TO RELATED APPLICATIONS

This application claims benefit of priority from U.S. Provisional Application No. 63/382,215 filed on Nov. 3, 2022, the entire contents of which are incorporated herein by reference.

### TECHNICAL FIELD

The invention relates to methods for the efficient regeneration of sorbents such as those used for the direct capture and separation of carbon dioxide (CO₂) and/or water from the atmosphere. Temperature responsive bimetallic alloy strips, gores, or sheets are utilized to guide heated gas or steam flows to cooler regions of adsorbent beds undergoing regeneration.

### BACKGROUND

Global warming is posing devastating effects on our climate, health, and communities. Coastal flooding due to rising sea levels, extended wildfire seasons, as well as more destructive hurricanes are the direct impacts of climate change. Moreover, global food and water security are at stake. There is a consensus among scientists that global warming is directly linked to the increase in the level of greenhouse gases in the atmosphere. Carbon dioxide (CO₂) is a major greenhouse gas and its concentration in the atmosphere has sharply increased over the past century due to the burning of fossil fuels. Although efforts are underway to move toward renewable energy sources that do not emit greenhouse gases, shifting our energy supply to completely renewable sources is not possible in the near term and requires further technological advancements and significant global investments. Therefore, there is a growing need for technologies that can efficiently capture carbon dioxide from the flue gas of power plants and other industrial processes and, increasingly, even from ambient air. The latter is known as direct air capture (DAC).

CO₂ capture processes can utilize some type of regenerable adsorbent bed to capture the CO₂ from a gas or air stream (see, for example, Sanz-Perez, et al., Chemical Reviews, 2016, 116, 11840-11876). In one approach, ambient air or flue gas is moved through a bed of a solid sorbent that is effective at selectively capturing a significant portion of the CO₂ therein. Once the sorbent reaches a level of significant saturation of CO₂, it needs to be regenerated in a separate step. During regeneration, the adsorbent bed is treated in some fashion to cause the CO₂ to desorb from the sorbent. The released CO₂ is subsequently captured, and the regenerated sorbent can then be returned to the first step and reused to capture more CO₂. Due to the low concentrations (currently a little over 400 parts per million) of CO₂ in ambient air, high volumes of ambient air need to be moved and processed in a DAC process, necessitating high efficiency to be practical.

Solid CO₂ sorbents include various zeolites or molecular sieves; amine-functionalized silicious, inorganic, activated carbon, graphitic, metal organic framework (MOF) or polymeric supports; amine-functionalized carbon, glass, cellulosic, or polymeric fibers; and basic or weakly basic ion exchange resins (see, for example, Samanta, et al., Industrial & Engineering Chemistry Research, 2012, 51, 1438-1463). In some cases, the solid CO₂ sorbents are utilized in powder or pellet form in packed bed configurations. In other cases, the solid CO₂ sorbents are utilized in fibrous webs, mats, or woven fabrics through which air is passed. In still other cases, the solid CO₂ sorbents are formed into structured monoliths or other structured forms such as sheets, films, membranes, or plates through or around which air may be passed.

Some of the sorbents utilized for CO₂ capture also adsorb water vapor in a competitive fashion, especially since water is typically present in ambient air at a concentration higher than that of CO₂. Therefore, in some DAC applications, separate sorbent beds including desiccants are utilized to dry the air before it passes through the CO₂ sorbent and must also be regenerated by treating to release adsorbed water. In some cases, for example as described in U.S. Pat. No. 11,446,605, the desorbed water can be collected, purified, and utilized as drinking water or for other human uses since freshwater resources are becoming short due to growing demand and global warming. In fact, there has been a growing interest in harvesting water directly from the air—see, for example, Zhou, et al. in ACS Materials Letters, 2020, 2, 671-684 and Bagheri in Water Resources and Industry, 2018, 20, 23-28. One advantage is that it can potentially be located anywhere on earth, but, like DAC, must be highly efficient to be practical at large scale.

The captured water or CO₂ is desorbed during the sorbent regeneration process, which usually involves purging with a heated gas or applying heat and vacuum to the adsorbent bed to desorb and remove the sorbate. There is great interest in being able to heat the adsorbent beds quickly and evenly to conserve energy and to optimize cycle times. Thermal jackets or surface heaters are common heating methods but offer poor performance (cycle time) with the bulky adsorbent beds filled with insulative sorbent materials typically utilized for water and/or CO₂ capture. Uneven airflow, temperature distributions, and channeling can all reduce sorbent regeneration efficiency, therefore a method of mitigating these inefficiencies is needed.

### SUMMARY

This invention provides efficient ways to heat an adsorbent bed, allowing for faster and more even heat transfer. In some embodiments, heat responsive bimetallic alloy strips, gores, or sheets are utilized to guide heated gas or steam flows to cooler regions of adsorbent beds undergoing regeneration. The invention provides a passive system for reactor thermal or fluid flow and improves overall heating and regeneration efficiency.

In an embodiment, the invention relates to a system to heat and regenerate an adsorbent bed including one or more chemical moieties adsorbed onto the adsorbent bed, the system comprising:
a) a reactor with an inlet side and an outlet side, the reactor including an adsorbent bed comprising a sorbent, the adsorbent bed affixed and sealed within the reactor such that a flow of gas entering through the inlet side of the reactor passes through the adsorbent bed to the outlet side of the reactor;
b) a gas-moving device configured to flow a heated gas stream into the inlet side of the reactor; and
c) heat-responsive fins embedded into and extending out of the adsorbent bed, the heat-responsive fins configured to undergo a thermal deflection upon being heated by the heated gas stream such that the flow of the heated gas stream from the inlet side of the reactor is directed to a cooler part of the adsorbent bed.

In another embodiment, the invention relates to an adsorbent bed comprising:
a sorbent; and
a plurality of heat-responsive fins embedded into and extending out of an outer wall of the adsorbent bed,
wherein the heat-responsive fins are configured to undergo a thermal deflection upon heating, and
wherein the adsorbent bed is affixed and sealed within a reactor such that a flow of gas entering through an inlet side of the reactor passes through the adsorbent bed to an outlet side of the reactor.

In another embodiment, the invention relates to a method to evenly heat and regenerate an adsorbent bed including one or more chemical moieties adsorbed onto the adsorbent bed, the method comprising:
a. providing an adsorbent bed including a plurality of heat-responsive fins embedded into and extending out of an outer wall of the adsorbent bed, wherein the heat-responsive fins have a first configuration at temperatures below a predetermined temperature;
b. flowing a heated gas stream through the adsorbent bed; and
c. when a region of the outer wall corresponding to each of the plurality of heat-responsive fin exceeds the predetermined temperature, each of the plurality of heat-responsive fins corresponding to the region of the outer wall undergoes a thermal deflection to a second configuration such that the flow of the heated gas is directed to a region of the adsorbent bed that is below the predetermined temperature.

In another embodiment, the invention relates to a method of heating and regenerating a sorbent included in an adsorbent bed, where the adsorbent bed is sealed within a reactor and the adsorbent bed includes heat-responsive fins having a first configuration, the method comprising:
flowing a heated gas stream through an inlet side of the reactor such that the heated gas stream passes through the adsorbent bed;
desorbing one or more chemical moieties from the sorbent as the heated gas stream passes through the adsorbent bed;
discharging the heated gas stream and the one or more desorbed chemical moieties through an outlet side of the reactor after the heated gas stream passes through the adsorbent bed; and
when a region of the adsorbent bed reaches a predetermined temperature, each of the heat-responsive fins corresponding to the region deflects from the first configuration to a second configuration to allow the headed gas stream to reach another region of the adsorbent bed.

In another embodiment, the invention relates to a method to evenly heat and regenerate an adsorbent bed including one or more chemical moieties adsorbed onto the adsorbent bed, the method comprising:
a. providing an adsorbent bed including a plurality of heat-responsive fins, each of the plurality of heat-responsive fins are embedded into and extend out of a different region of an outer wall of the adsorbent bed, wherein the plurality of heat-responsive fins are configured to have a first configuration at temperatures below a predetermined temperature;
b. flowing a heated gas stream through the adsorbent bed;
c. when a first region of the outer wall corresponding to a first heat-responsive fin exceeds the predetermined temperature, the first heat-responsive fin undergoes a thermal deflection from the first configuration to a second configuration; and
d. when a second region of the outer wall corresponding to a second heat-responsive fin exceeds the predetermined temperature, the second heat-responsive fin undergoes a thermal deflection from the first configuration to the second configuration, wherein a temperature of the second region of the outer wall is below the predetermined temperature when the first heat-responsive fin is in the second configuration.

In another embodiment, a method to evenly heat and regenerate an adsorbent bed including one or more chemical moieties adsorbed onto the adsorbent bed, the method comprising:
a. providing an adsorbent bed including a plurality of heat-responsive fins, each of the plurality of heat-responsive fins embedded into and extending out of a different region of an outer wall of the adsorbent bed, wherein the plurality of heat-responsive fins have a first configuration at temperatures below a predetermined temperature;
b. flowing a heated gas stream through the adsorbent bed;
c. when any initial region of the outer wall comprising one heat-responsive fin exceeds the predetermined temperature, the one heat-responsive fin in such region undergoes a thermal deflection from the first configuration to a second configuration; and
d. when any subsequent region of the outer wall comprising another heat-responsive fin exceeds the predetermined temperature, the other heat-responsive fin in such subsequent region undergoes a thermal deflection from the first configuration to the second configuration, wherein each heat-responsive fin in the second configuration directs the heated gas stream toward regions of the outer wall comprising heat-responsive fins still in the first configuration.

### BRIEF DESCRIPTION OF THE DRAWINGS

The accompanying drawings, which are incorporated herein and constitute a part of this specification, illustrate exemplary embodiments. These and other objects, features and attendant advantages of the present invention will be more fully appreciated or become better understood when considered in conjunction with the accompanying drawings, wherein:

FIG. 1A depicts a flow-through adsorbent bed configuration with embedded thermos bimetallic alloy fins in a non-deformed configuration according to an embodiment of the present disclosure;

FIG. 1B depicts a flow-through adsorbent bed configuration with embedded thermo bimetallic alloy fins after responding to increasing temperature by curling, thereby altering heated gas flow to cooler parts of the adsorbent bed according to an embodiment of the present disclosure;

FIG. 2 depicts a thermo bimetallic fin arrangement in a radial flow bed reactor with subsequent sample calculations estimating the deflection and spacing of each fin. Fin geometry, spacing, installation, and orientation are for reference only and do not indicate a fixed configuration for all implementations according to an embodiment of the present disclosure;

FIG. 3 depicts a method of using springs to allow the fins to bend at a specific temperature instead of a gradual deflection over a temperature range. A tuned torsional spring prevents movement of the fin until a specific fin force overcomes the spring force according to an embodiment of the present disclosure;

FIG. 4A depicts a structured sorbet bed with flow channels through the bed according to an embodiment of the present disclosure;

FIG. 4B is a top view of the structured sorbent bed with thermo bimetallic fins extending from the front face of the bed in an open (straight) fashion according to an embodiment of the present disclosure; and

FIG. 4C is a top view of the structured sorbent bed with thermo bimetallic fins extending from the front face of the bed in a closed (bent) fashion according to an embodiment of the present disclosure.

### DETAILED DESCRIPTION

In an embodiment, the invention relates to a system to heat and regenerate an adsorbent bed including one or more chemical moieties adsorbed onto the adsorbent bed, the system comprising:
a) a reactor with an inlet side and an outlet side, the reactor including an adsorbent bed comprising a sorbent, the adsorbent bed affixed and sealed within the reactor such that a flow of gas entering through the inlet side of the reactor passes through the adsorbent bed to the outlet side of the reactor;
b) a gas-moving device configured to flow a heated gas stream into the inlet side of the reactor; and
c) heat-responsive fins embedded into and extending out of the adsorbent bed, the heat-responsive fins configured to undergo a thermal deflection upon being heated by the heated gas stream such that the flow of the heated gas stream from the inlet side of the reactor is directed to a cooler part of the adsorbent bed.

In another embodiment, the invention relates to an adsorbent bed comprising:
a sorbent; and
a plurality of heat-responsive fins embedded into and extending out of an outer wall of the adsorbent bed,
wherein the heat-responsive fins are configured to undergo a thermal deflection upon heating, and
wherein the adsorbent bed is affixed and sealed within a reactor such that a flow of gas entering through an inlet side of the reactor passes through the adsorbent bed to an outlet side of the reactor.

In another embodiment, the invention relates to a method to evenly heat and regenerate an adsorbent bed including one or more chemical moieties adsorbed onto the adsorbent bed, the method comprising:
a. providing an adsorbent bed including a plurality of heat-responsive fins embedded into and extending out of an outer wall of the adsorbent bed, wherein the heat-responsive fins have a first configuration at temperatures below a predetermined temperature;
b. flowing a heated gas stream through the adsorbent bed; and
c. when a region of the outer wall corresponding to each of the plurality of heat-responsive fin exceeds the predetermined temperature, each of the plurality of heat-responsive fins corresponding to the region of the outer wall undergoes a thermal deflection to a second configuration such that the flow of the heated gas is directed to a region of the adsorbent bed that is below the predetermined temperature.

Air and other gases are processed through adsorbent beds to remove water, CO₂, or other chemical moieties such as acid gases including hydrogen sulfide, hydrogen chloride, sulfur oxides (SOₓ) and nitrogen oxides (NOₓ). Fans, blowers, compressors, and other types of air- and gas-moving equipment are utilized to force the gas through the sorbent(s) included within the adsorbent beds during an adsorption step. Depending on the identity and selectivity of the particular sorbent utilized in the adsorbent bed, one or more of the various chemical moieties that may be present in the gas stream is captured (adsorbed) by the sorbent and held in the adsorbent bed while a purified gas stream exits the adsorbent bed. Once the sorbent becomes sufficiently saturated with the adsorbed chemical moieties, it is regenerated by desorption of the adsorbed chemical moieties.

One approach to regenerate an adsorbent bed is to heat the bed to a temperature at which the adsorbed chemical moieties desorb from the sorbent. This may be accomplished by using thermal jackets or surface heaters around the adsorbent bed or embedded heating elements within the adsorbent bed, although this adds significant complexity to the design and operation of the systems and suffers from poor performance as heat distribution is generally uneven. Heating can be more efficiently accomplished by using a gas moving device to flow a heated gas (e.g., dry air, nitrogen, etc.) or fluid (e.g., steam) stream through the adsorbent bed to heat the sorbent and to purge the desorbed chemical moieties out of the adsorbent bed. Methods and equipment that supply the needed heated gas or fluid streams to the adsorbent beds include, but are not limited to, heat exchangers, steam boilers, fans, blowers, and compressors. Depending on the system configuration, fans, blowers, or compressors are already present in the system to move air through the adsorbent bed during the adsorption step. Therefore, there just needs to be a source of heated purge gas that can be pushed or pulled through the adsorbent bed via the existing fan, blower, or compressor, as the case may be. In some embodiments of the present invention, steam may be utilized as the source of heat for the regeneration process. Steam is commonly available and serves as an efficient heat source. Steam is available at a variety of pressures and the pressure of the steam may serve as the motive force to move the steam through the adsorbent bed. Furthermore, the adsorbent beds are commonly evacuated to a low pressure using a vacuum pump after the adsorption step and prior to the regeneration to remove residual air from the adsorbent bed, both to provide a higher purity of the desorbed chemical moieties and to protect the sorbent from oxidation at the elevated regeneration temperatures. In some embodiments of the present invention, a vacuum pump is utilized to pull the heated gas or steam stream through the adsorbent bed.

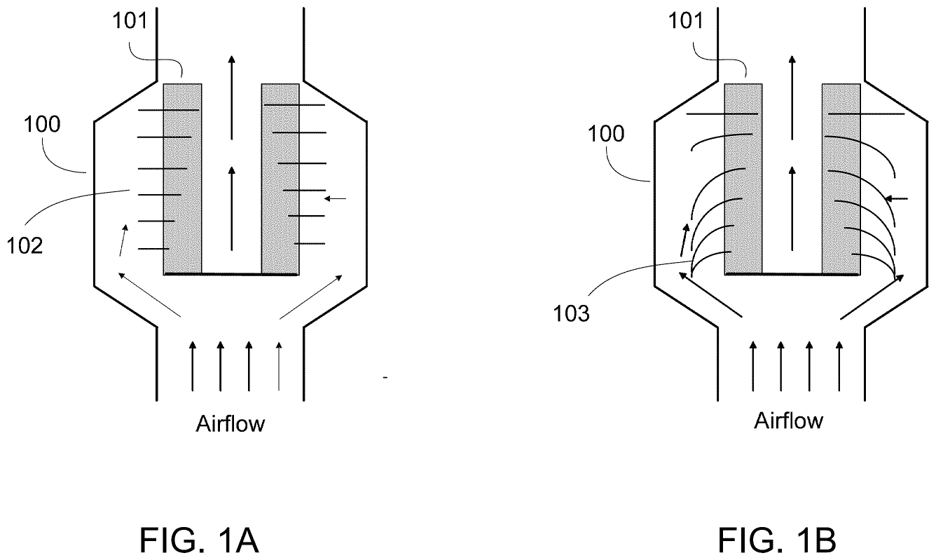

As shown in FIG. 1A, heat-responsive bimetallic alloy strips, gores, or sheet metal (102) are utilized in an axial or radial flow reactor to dynamically heat up areas below or above a specific setpoint. The adsorbent bed including the sorbent (101) is affixed within the reactor (100) and sealed such that gas entering the inlet side of the reactor flows through the adsorbent bed to the outlet side of the reactor. The bimetallic alloy materials are comprised of sheets or strips of two different metals or metal alloys that are bonded together to form a two-ply or multi-ply laminate. A plurality of the heat-responsive bimetallic materials are embedded into and extend out of the adsorbent bed into the inlet side of the reactor in the form of fins. Upon heating, there is a thermal deflection of the bimetallic materials caused by the mismatched coefficients of thermal expansion of the two different materials forming the bimetallic alloy strips. At cold ambient temperatures, fins are tuned in a geometry (e.g., generally straight) that is conducive to high gas flow through the sorbent bed during the adsorption stage.

During the desorption stage, heated air, steam, or other desorption gas flows through the adsorbent bed. As shown in FIG. 1B, as a particular region or fin approaches a specific desorption temperature, the fins begin to curl to restrict airflow to the region of the adsorbent bed corresponding to the curled fin (103). Each of the plurality of fins independently curls to a differing extent depending upon its instantaneous temperature. This allows hot gas to bypass to regions of the adsorbent bed already at desorption temperatures to more efficiently reach regions of the adsorbent bed not yet at desorption temperatures, providing more even heating for faster overall desorption cycle time. Tuning can be done through selection of the following: varying the composition of the thermo bimetallic material, or varying the thickness, length of fin, or fin depth into the sorbent. A brief description of each method of tuning is as follows.

Changing the composition of the thermo bimetallic material will allow tuning as different materials have different temperature responses. Some materials will activate at higher or lower temperatures with more or less fin force. Outside of the composition of the fin material, changing the thickness of the fin will increase or decrease the fin force and changing the length of the fin will change how quickly the fin closes or blocks the gas passageway. A longer fin will have to respond quicker or earlier relative to a shorter fin of the same properties and thickness. A fin having a smaller thickness will respond quicker or earlier relative to a fin having a greater thickness. Lastly, varying the fin depth embedded depth, while keeping the non-embedded length consistent between all fins, will tune the response as increased surface area in the sorbent will better transfer heat between the sorbent and the fin. This is advantageous as the fin will respond quicker to the temperature of the sorbent region it is embedded in.

In an exemplary embodiment, desorption can be performed either from a front or rear of the sorbent (101) in an adsorbent bed. That is, air flow may be directed such that the air or gas impacts a first surface of a fin when the flow is provided from the front of the sorbent (101) and the air or gas impacts a second surface, opposite the first surface of the fin when the flow is provided from a rear or the sorbent (101). In some embodiments, the direction of the air flow during the adsorption step is the same as the direction of the heated gas or steam flow during the desorption step. In some embodiments, the direction of the heated gas or steam flow is opposite to that of the direction of the air flow during the adsorption step.

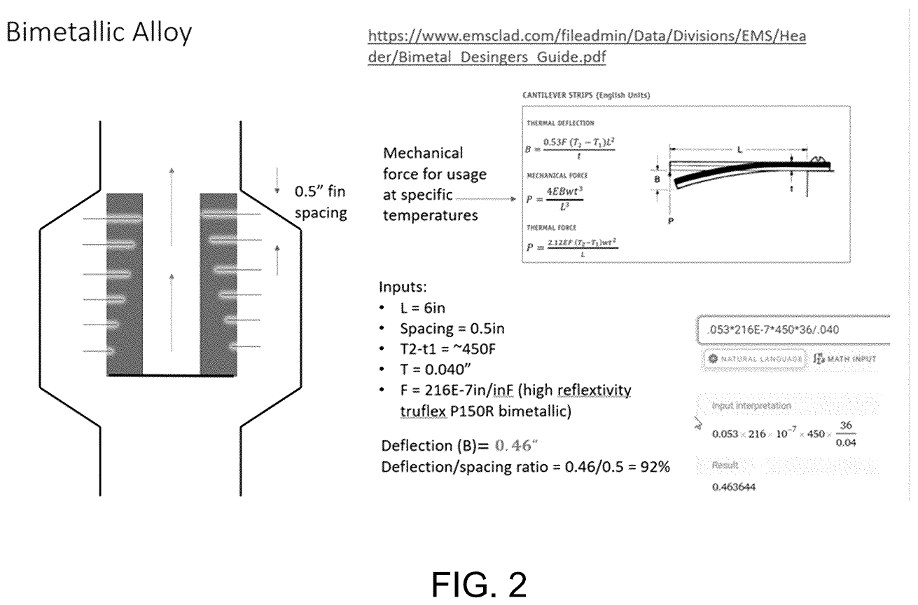

The calculations shown in FIG. 2 indicate that commercially available bimetallic alloy strips (TRUFLEX P150R) give sufficient deflection such that reasonable fin spacing (about 0.5 inches in one example embodiment) is accommodated in a representative radial flow packed bed arrangement. An arrangement of thermo bimetallic fins can be used in any of a radial flow reactor, linear packed bed reactor, pleated reactor, or other common reactor geometries for low concentration chemical streams.

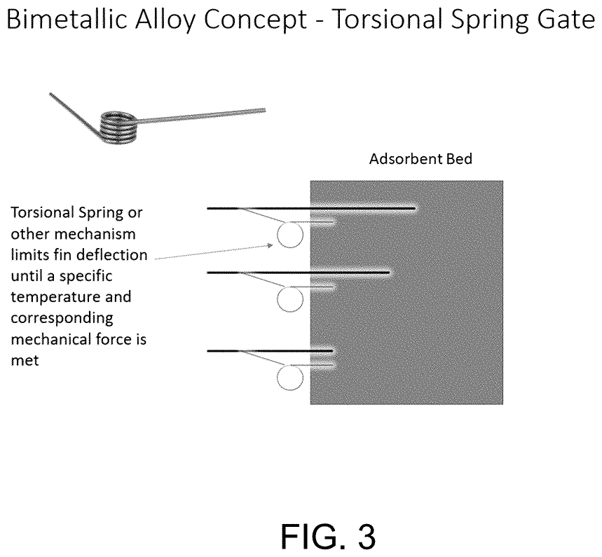

In another example embodiment, mechanical gates can be added to prevent flow obstruction until the fin has reached a particular temperature and corresponding mechanical force to overcome the gate force. One such example of limiting fin deflection is with a torsional spring as shown in FIG. 3. The torsional spring holds the fin in the fully open position and prevents the fin from curling until the desired desorption temperature is reached, thereby maintaining a high flow of the heating gas to the nearby region of the adsorbent bed until it has reached a sufficient temperature. That is, when a region of the adsorbent bed reaches sufficient temperature, the torsional spring deforms allowing the fin corresponding to the sufficient temperature region to curl.

In some embodiments of the invention, one or more zeolites are used as the sorbent in the adsorbent bed. Low-silica zeolites with the faujasite (FAU) framework topology are commercially available at a relatively low cost (e.g., 13X and Y) and are amongst the most commonly used adsorbents in industrial gas adsorption and separation processes. Thus, in some embodiments of the invention, the sorbent in the adsorbent bed is a 13X zeolite. In other embodiments of the invention, the sorbent in the adsorbent bed is an erionite zeolite, a chabazite zeolite, a mordenite zeolite, a clinoptilolite zeolite, a 4A zeolite, or a 5A zeolite. In yet other embodiments of the invention, the adsorbent bed may contain two or more sorbents selected from a 13X zeolite, an erionite zeolite, a chabazite zeolite, a mordenite zeolite, a clinoptilolite zeolite, a 4A zeolite, and a 5A zeolite.

In some embodiments of the invention, one or more desiccants are used as the sorbent in the adsorbent bed. Common desiccants include silica, alumina, calcium sulfate, zeolites, and various types of clays such as montmorillonite. The desiccants may be in the form of powders, pellets, beads, flakes, or granules. In some embodiments of the present invention, activated carbons or charcoals are used as the sorbent in the adsorbent bed.

In some embodiments of the present invention, one or more amine functionalized solid sorbents are used as the sorbent in the adsorbent bed, including (i) polyamines supported on inorganic oxides; (ii) polyamines supported on other materials; and (iii) polyamine sorbents that do not feature a support material. See the variety of solid amine-based sorbents described in Hamdy, et al., Materials Advances, 2021, 2, 5843-5880.

In some embodiments of the present invention, one or more solid sorbents are used in a structured adsorbent bed. In some embodiments of the present invention, the solid sorbents are coated onto a suitable structuring substrate such as a flat plate, fiber, fiber bundle, or monolith. In some embodiments of the present invention, the solid sorbents are coated onto or embedded into a fabric, felt, membrane, or mat. In an exemplary embodiment, the one or more solid sorbents may be used in reactor 100.

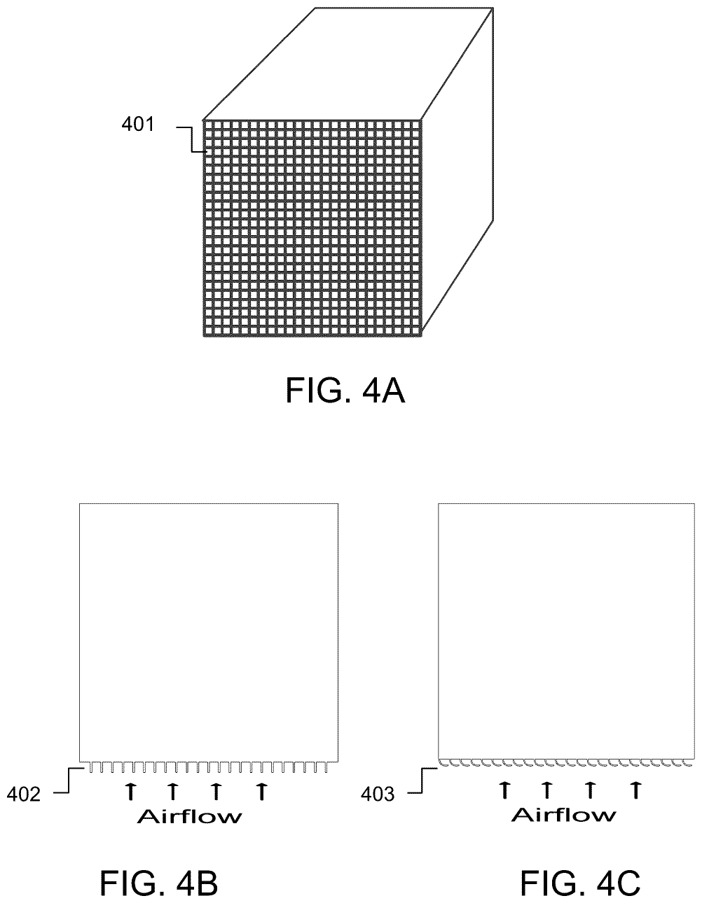

Sorbent-coated monoliths, such as shown in FIG. 4A, generally have flow channels (401) that run through the length of the monolith, allowing gas flow in one direction through the monolith. In an exemplary embodiment, the channels (401) are provided throughout the length of the monolith such that the gas enters one side of the monolith, flows through the length of the monolith via the channels (401), and exits the opposite side. In some embodiments, such as shown for example in FIG. 1A, the monoliths have rectangular flow channels. In some embodiments, the monoliths may have circular flow channels. In some embodiments, the monoliths may have hexagonal flow channels in a honeycomb type structure.

As shown in FIG. 4B, strips (fins) of the thermo bimetallic material (402) may be embedded in or placed on one or more outside faces of the monolith, parallel to the direction of flow, such that gas flow is not obstructed by the fins in a normal unbent state. In some embodiments of the present invention, the strips (fins) of the thermo bimetallic material (402) are be embedded in or placed on the outside front face of the monolith, i.e., the face where the gas flow enters the monolith.

Any number of fins may be disposed on a face of the monolith. For example, one fin may be disposed to correspond to each channel. In an alternative embodiment, one fin may be disposed to correspond to a plurality of channels. For example, a single fin can correspond to an entire column of channels such that one fin, when activated and bent, covers a column of channels in the monolith. Alternatively, a single fin can correspond to an entire row of channels such that one fin, when activated and bent, covers a row of channels in the monolith. A plurality of fins may be disposed with respect to the rows or columns of the matrix. For example, a plurality of fins can be mounted on the monolith such that each of the plurality of fins corresponds to one row or column of the matrix where a total number of fins corresponds to a total number of rows or columns of the matrix, respectively.

In another embodiment, a plurality of fins may be disposed in a single row or a single column. That is, one row or one column can include a plurality of fins and the number of rows or columns may be the same or different for each fin. For example, a first fin may be provided in a first portion of a row of the channels of the matrix and the fin may correspond to three or four channels and a second fin in a second portion of the same row may correspond to seven or eight channels.

As regions of the monolith begin to warm, the local fins will begin to bend (403), thereby restricting gas flow in those regions as shown in FIG. 4C. Sorbents supported in a plate, sheet, or fiber type structure are generally arranged inside of a bed or contactor structure which holds the plates, sheets, or fibers in place and allows for gas flow in one or two directions through the structure. When the sorbents are supported in a plate or sheet format, they are generally supported in a parallel arrangement within the bed or contactor such that air or gas may flow in a parallel direction between the sheets or plates. When the sorbents are supported in a fiber format, they are generally supported in a parallel arrangement within the bed or contactor such that air or gas may flow around and between the supported fibers in a direction perpendicular to the length of the fibers. Similar to the arrangement described above for monoliths, strips (fins) of the thermo bimetallic material may be embedded into or placed on one or more outside faces of the support structures, parallel to the direction of flow, such that gas flow is not obstructed by the fins in their normal unbent state. However, as regions of the supported sorbents begin to warm, the local fins will begin to bend, thereby restricting gas flow into the support structure in those regions. This will divert gas flow to cooler regions of the structure thereby decreasing the total gas heat input needed to warm all regions of the sorbent and reducing the desorption time.

As those skilled in the art will appreciate, numerous modifications and variations of the present invention are possible in light of these teachings, and all such are contemplated hereby. All of the references cited herein are incorporated by reference herein for all purposes, or at least for their teachings in the context presented.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples of accomplishing a more general goal that also may be accomplished in another way. Those skilled in the art will appreciate that the features described above can be combined in various ways to form multiple variations of the invention.

### EXEMPLARY EMBODIMENTS OF THE INVENTION

In an exemplary embodiment, the invention relates to a method of heating and regenerating a sorbent included in an adsorbent bed, where the adsorbent bed is sealed within a reactor and the adsorbent bed includes heat-responsive fins having a first configuration, the method comprising:
flowing a heated gas stream through an inlet side of the reactor such that the heated gas stream passes through the adsorbent bed;
desorbing one or more chemical moieties from the sorbent as the heated gas stream passes through the adsorbent bed;
discharging the heated gas stream and the one or more desorbed chemical moieties through an outlet side of the reactor after the heated gas stream passes through the adsorbent bed; and
when a region of the adsorbent bed reaches a predetermined temperature, each of the heat-responsive fins corresponding to the region deflects from the first configuration to a second configuration to allow the headed gas stream to reach another region of the adsorbent bed.

In another exemplary embodiment, the invention relates to a method to evenly heat and regenerate an adsorbent bed including one or more chemical moieties adsorbed onto the adsorbent bed, the method comprising:
a. providing an adsorbent bed including a plurality of heat-responsive fins, each of the plurality of heat-responsive fins are embedded into and extend out of a different region of an outer wall of the adsorbent bed, wherein the plurality of heat-responsive fins are configured to have a first configuration at temperatures below a predetermined temperature;
b. flowing a heated gas stream through the adsorbent bed;
c. when a first region of the outer wall corresponding to a first heat-responsive fin exceeds the predetermined temperature, the first heat-responsive fin undergoes a thermal deflection from the first configuration to a second configuration; and
d. when a second region of the outer wall corresponding to a second heat-responsive fin exceeds the predetermined temperature, the second heat-responsive fin undergoes a thermal deflection from the first configuration to the second configuration, wherein a temperature of the second region of the outer wall is below the predetermined temperature when the first heat-responsive fin is in the second configuration.

In another exemplary embodiment, a method to evenly heat and regenerate an adsorbent bed including one or more chemical moieties adsorbed onto the adsorbent bed, the method comprising:
a. providing an adsorbent bed including a plurality of heat-responsive fins, each of the plurality of heat-responsive fins embedded into and extending out of a different region of an outer wall of the adsorbent bed, wherein the plurality of heat-responsive fins have a first configuration at temperatures below a predetermined temperature;
b. flowing a heated gas stream through the adsorbent bed;
c. when any initial region of the outer wall comprising one heat-responsive fin exceeds the predetermined temperature, the one heat-responsive fin in such region undergoes a thermal deflection from the first configuration to a second configuration; and
d. when any subsequent region of the outer wall comprising another heat-responsive fin exceeds the predetermined temperature, the other heat-responsive fin in such subsequent region undergoes a thermal deflection from the first configuration to the second configuration,
wherein each heat-responsive fin in the second configuration directs the heated gas stream toward regions of the outer wall comprising heat-responsive fins still in the first configuration.

1. A system to heat and regenerate an adsorbent bed including one or more chemical moieties adsorbed onto the adsorbent bed, the system comprising:
a) a reactor with an inlet side and an outlet side, the reactor including an adsorbent bed comprising a sorbent, the adsorbent bed affixed and sealed within the reactor such that a flow of gas entering through the inlet side of the reactor passes through the adsorbent bed to the outlet side of the reactor;
b) a gas-moving device configured to flow a heated gas stream into the inlet side of the reactor; and
c) heat-responsive fins embedded into and extending out of the adsorbent bed, the heat-responsive fins configured to undergo a thermal deflection upon being heated by the heated gas stream such that the flow of the heated gas stream from the inlet side of the reactor is directed to a cooler part of the adsorbent bed.

2. An adsorbent bed comprising:
a sorbent; and
a plurality of heat-responsive fins embedded into and extending out of an outer wall of the adsorbent bed,
wherein the heat-responsive fins are configured to undergo a thermal deflection upon heating, and
wherein the adsorbent bed is affixed and sealed within a reactor such that a flow of gas entering through an inlet side of the reactor passes through the adsorbent bed to an outlet side of the reactor.

3. A method to evenly heat and regenerate an adsorbent bed including one or more chemical moieties adsorbed onto the adsorbent bed, the method comprising:
a. providing an adsorbent bed including a plurality of heat-responsive fins embedded into and extending out of an outer wall of the adsorbent bed, wherein the heat-responsive fins have a first configuration at temperatures below a predetermined temperature;
b. flowing a heated gas stream through the adsorbent bed; and
c. when a region of the outer wall corresponding to each of the plurality of heat-responsive fin exceeds the predetermined temperature, each of the plurality of heat-responsive fins corresponding to the region of the outer wall undergoes a thermal deflection to a second configuration such that the flow of the heated gas is directed to a region of the adsorbent bed that is below the predetermined temperature.

4. The system of claim 1, wherein the plurality of heat-responsive fins comprise at least one of bimetallic alloy strips, gores, or sheets.

5. The system of claim 4, further comprising:
a torsional spring corresponding to each of the plurality of heat-responsive fins,
wherein the torsional spring limits deflection of each of the plurality of heat-responsive fins until a specific temperature is reached.

6. The system of claim 1, further comprising:
a plurality of torsional springs,
wherein each of the plurality of torsional springs corresponds to one of the plurality of heat-responsive fins, and
wherein each of the plurality of torsional springs limits deflection of the corresponding heat-responsive fin until a specific temperature is reached.

7. The method of claim 3, further comprising:
flowing a heated gas stream through an inlet side of the reactor such that the heated gas stream passes through the adsorbent bed;
desorbing one or more chemical moieties from the sorbent as the heated gas stream passes through the adsorbent bed;
discharging the heated gas stream and the one or more desorbed chemical moieties through an outlet side of the reactor after the heated gas stream passes through the adsorbent bed; and
when a region of the adsorbent bed reaches a predetermined temperature, each of the heat-responsive fins corresponding to the region deflects from the first configuration to a second configuration to allow the headed gas stream to reach another region of the adsorbent bed.

8. The method of claim 3, further comprising:
a. providing an adsorbent bed including a plurality of heat-responsive fins, each of the plurality of heat-responsive fins are embedded into and extend out of a different region of an outer wall of the adsorbent bed, wherein the plurality of heat-responsive fins are configured to have a first configuration at temperatures below a predetermined temperature;
b. flowing a heated gas stream through the adsorbent bed;
c. when a first region of the outer wall corresponding to a first heat-responsive fin exceeds the predetermined temperature, the first heat-responsive fin undergoes a thermal deflection from the first configuration to a second configuration; and
d. when a second region of the outer wall corresponding to a second heat-responsive fin exceeds the predetermined temperature, the second heat-responsive fin undergoes a thermal deflection from the first configuration to the second configuration,
wherein a temperature of the second region of the outer wall is below the predetermined temperature when the first heat-responsive fin is in the second configuration.

9. The method of claim 3, further comprising:
a. providing an adsorbent bed including a plurality of heat-responsive fins, each of the plurality of heat-responsive fins embedded into and extending out of a different region of an outer wall of the adsorbent bed, wherein the plurality of heat-responsive fins have a first configuration at temperatures below a predetermined temperature;
b. flowing a heated gas stream through the adsorbent bed;
c. when any initial region of the outer wall comprising one heat-responsive fin exceeds the predetermined temperature, the one heat-responsive fin in such region undergoes a thermal deflection from the first configuration to a second configuration; and
d. when any subsequent region of the outer wall comprising another heat-responsive fin exceeds the predetermined temperature, the other heat-responsive fin in such subsequent region undergoes a thermal deflection from the first configuration to the second configuration,
wherein each heat-responsive fin in the second configuration directs the heated gas stream toward regions of the outer wall comprising heat-responsive fins still in the first configuration.
